(19) United States
(12) Patent Application Publication
(10) Pub. No.: US 2015/0270680 A1
(43) Pub. Date: Sep. 24, 2015

(54) IN-BAND PUMPING 975-NANOMATER SINGLE-FREQUENCY FIBER LASER WITH YTTERBIUM-DOPED SILICA OPTICAL FIBER

(71) Applicant: TIANJIN OPTERA LASER TECHNOLOGY CO., LTD., Tianjin (CN)

(72) Inventors: Wei Shi, Tianjin (CN); Zhuo Zhang, Tianjin (CN)

(73) Assignee: TIANJIN OPTERA LASER TECHNOLOGY CO., LTD.

(21) Appl. No.: 14/598,232

(22) Filed: Jan. 16, 2015

(30) Foreign Application Priority Data
Mar. 20, 2014 (CN) 201410103021.6

(51) Int. Cl. H01S 3/094

(52) U.S. Cl. CPC H01S 3/094042

(57) ABSTRACT

The present invention relates to an in-band pumping 975-nanomater single-frequency fiber laser with an ytterbium-doped silica optical fiber, comprising a 915-nanometer in-band pumping laser, an optical fiber wavelength division multiplexer, a high-reflectivity optical fiber Bragg grating, an ytterbium-doped silica optical fiber, a low-reflectivity optical fiber Bragg grating and an output optical fiber. The 915-nanometer in-band pumping laser servers as an in-band pumping source. A pumping input port of the optical fiber wavelength division multiplexer is connected to the in-band pumping laser. One end of the high-reflectivity optical fiber Bragg grating is connected to an output port of the optical fiber wavelength division multiplexer, while the other end thereof is connected to one end of the ytterbium-doped silica optical fiber. The low-reflectivity optical fiber Bragg grating is connected to the other end of the ytterbium-doped silica optical fiber. Single-frequency laser light is ultimately output from the output optical fiber connected to the other end of the low-reflectivity optical fiber Bragg grating. The in-band pumping 975-nanomater single-frequency fiber laser with an ytterbium-doped silica optical fiber provided by the present invention has the advantages of simple structure, compact volume, high working stability, convenient manufacturing and the like.

### CROSS-REFERENCE TO RELATED APPLICATIONS

This application is a continuation of, and claims priority to, Chinese

Patent Application No. 201410103021.6 with a filing date of Mar. 20, 2014, The content of the aforementioned application, including any intervening amendments thereto, is incorporated herein by reference.

### TECHNICAL FIELD

The present invention relates to the technical field of fiber lasers, in particular to an in-band pumping 975-nanomater single-frequency fiber laser with an ytterbium-doped silica optical fiber.

### BACKGROUND OF THE PRESENT INVENTION

Optical fiber lasers are lasers using a rare earth element doped glass fiber as a gain medium. By doping different rare earth elements (e.g., ytterbium, erbium, thulium, holmium, etc.), the working waveband of a filer laser may be expanded to various wavebands from ultraviolet to infrared. Compared with conventional all-solid-state lasers, filer lasers are compact in structure, easy for heat dissipation, stable in operation, high in resistance against interference and excellent in cost performance.

In some practical applications such as optical communication, laser holography, precise metering, laser light is required to have high monochromaticity and high coherence and to work in a simple-frequency state. Therefore, fiber lasers of single-longitudinal-mode outputs have been an active research field of the laser technology due to their characteristics of narrow line-width single-frequency output, good coherence, etc.

Single-frequency fiber lasers working at a wavelength below 1 μm have a broad application prospect. Due to their significant applications in nonlinear frequency conversion (e.g., they may be applied in developing single-frequency blue light sources), single-frequency fiber lasers have attracted more and more attention recently. Compared with optical fibers made of other materials, silica optical fibers have mature development and excellent mechanical properties. Therefore, it is of great importance to develop an in-band pumping 975-nanomater single-frequency fiber laser with an ytterbium-doped silica optical fiber.

### SUMMARY OF THE PRESENT INVENTION

To solve the above problem, an objective of the present invention is to provide an in-band pumping 975-nanometer single-frequency fiber laser with an ytterbium-doped silica optical fiber,

To achieve the above objective, the present invention provides an in-band pumping 975-nanomater single-frequency fiber laser with an ytterbium-doped silica optical fiber, including: a 915-nanometer in-band pumping laser, an optical fiber wavelength division multiplexer, a high-reflectivity optical fiber Bragg grating, an ytterbium-doped silica optical fiber, a low-reflectivity optical fiber Bragg grating and an output optical fiber, wherein the 915-nanometer in-band pumping laser servers as an in-band pumping source; a pumping input port of the optical fiber wavelength division multiplexer is connected to the in-band pumping laser; the 915-nanometer in-band pumping laser pumps the ytterbium-doped silica optical fiber after passing through the optical fiber wavelength division multiplexer, one end of the high-reflectivity optical fiber Bragg grating is connected to an output port of the optical fiber wavelength division multiplexer while the other end thereof is connected to one end of the ytterbium-doped silica optical fiber; the low-reflectivity optical fiber Bragg grating is connected to the other end of the ytterbium-doped silica optical fiber; and, single-frequency laser light is ultimately output from the output optical fiber connected to the other end of the low-reflectivity optical fiber Bragg grating.

The 915-nanometer in-band pumping laser is a semiconductor laser or an all-solid-state laser, and a gain optical fiber is pumped in an in-band pumping manner.

The high-reflectivity optical fiber Bragg grating and the low-reflectivity optical fiber Bragg grating form a laser chamber, and the central wavelengths of both the optical fiber Bragg gratings are greater than 915-nanometer.

The reflection spectrum bandwidth single-frequency output by the low-reflectivity optical fiber Bragg grating is below 4 GHz.

A connection between the optical fiber wavelength division multiplexer and the high-reflectivity optical fiber Bragg grating, a connection between the high-reflectivity optical fiber Bragg grating and the ytterbium-doped silica optical fiber, a connection between the ytterbium-doped silica optical fiber and the low-reflectivity optical fiber Bragg grating and a connection between the low-reflectivity optical fiber Bragg grating and the output optical fiber are all realized by means of welding.

The in-band pumping 975-nanomater single-frequency fiber laser with an ytterbium-doped silica optical fiber provided by the present invention has the advantages of simple structure, compact volume, high working stability, convenient manufacturing and the like.

### BRIEF DESCRIPTION OF THE DRAWINGS

FIG. 1 is a structural diagram of an in-band pumping 975-nanomater single-frequency fiber laser with an ytterbium-doped silica optical fiber according to the present invention; in which: 1: 915-nanometer in-band pumping laser; 2: Optical fiber wavelength division multiplexer; 3: High-reflectivity optical fiber Bragg grating; 4: Ytterbium-doped silica optical fiber; 5: Low-reflectivity optical fiber Bragg grating; and, 6: Output optical fiber.

### DETAILED DESCRIPTION OF THE PRESENT INVENTION

The in-band pumping 975-nanometer single-frequency fiber laser with an ytterbium-doped silica optical fiber provided by the present invention will he described as below in details with reference to the accompanying drawings by specific embodiments.

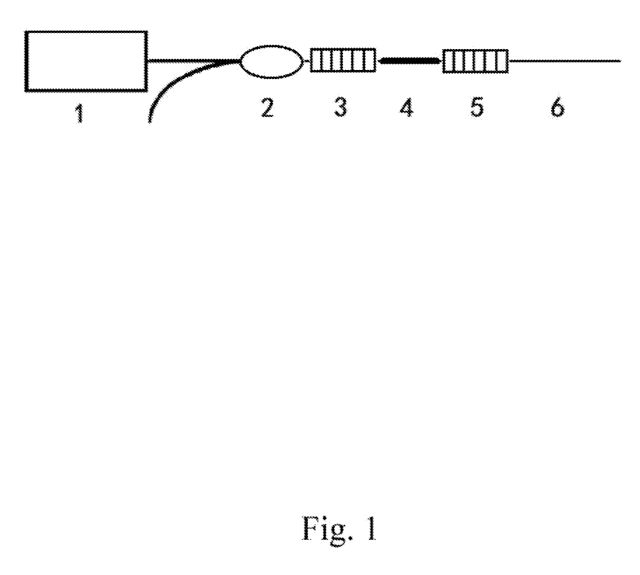

As shown in FIG. 1, the in-band pumping 975-nanomater single-frequency fiber laser with an ytterbium-doped silica optical fiber provided by the present invention includes a 915-nanometer in-band pumping laser 1, an optical fiber wavelength division multiplexer 2, a high-reflectivity optical fiber Bragg grating 3, an ytterbium-doped silica optical fiber 4, a low-reflectivity optical fiber Bragg grating 5 and an output optical fiber 6, wherein the 915-nanometer in-band pumping laser 1 servers as an in-band pumping source; a pumping input port of the optical fiber wavelength division multiplexer 2 is connected to the in-band pumping laser 1; the 915-nanometer in-band pumping laser 1 pumps the ytterbium-doped silica optical fiber after passing through the optical fiber wavelength division multiplexer 2; one end of the high-reflectivity optical fiber Bragg grating 3 is connected to an output port of the optical fiber wavelength division multiplexer 2, while the other end thereof is connected to one end of the ytterbium-doped silica optical fiber 4; the low-reflectivity optical fiber Bragg grating 5 is connected to the other end of the ytterbium-doped silica optical fiber 4. In this way, the two optical fiber Bragg gratings form a laser chamber with the gain optical fiber. Single-frequency laser light is ultimately output from the output optical fiber 6 connected to the other end of the low-reflectivity optical fiber Bragg grating 5.

A connection between the optical fiber wavelength division multiplexer 2 and the high-reflectivity optical fiber Bragg grating 3, a connection between the high-reflectivity optical fiber Bragg grating 3 and the ytterbium-doped silica optical fiber 4, a connection between the ytterbium-doped silica optical fiber 4 and the low-reflectivity optical fiber Bragg grating 5 and a connection between the low-reflectivity optical fiber Bragg grating 5 and the output optical fiber 6 are all realized by means of welding.

The pumping laser is a laser working at 915-nanometer. This laser may be a semiconductor laser or an all-solid-state laser, and a grain optical fiber is pumped in an in-band pumping manner.

The high-reflectivity optical fiber Bragg grating 3 and the low-reflectivity optical fiber Bragg grating 5 form a laser chamber, and the central wavelengths of both the optical fiber Bragg gratings are greater than 915-nanometer, such as 930 nm.

The laser light output in the present invention is single-frequency laser light which is obtained by reducing the length of the laser chamber and using narrow-band optical fiber Bragg gratings. The a space between laser longitudinal modes may be represented as

$$Δ v = \frac{c}{2 nL} ,$$

where c is the propagation velocity of light waves in vacuum, n is the reflectivity of an optical fiber core, and L is the length of the laser chamber. It can be seen from the expression that the space between laser longitudinal modes may be increased by reducing the length of the laser chamber, and single frequency laser light output is thus obtained. In the present invention, by using a highly ytterbium-doped optical fiber having a very short length (1-2 cm) and reducing the length of the grating pigtail, the length of the laser chamber is controlled at 2.5-3 cm. The low-reflectivity optical fiber Bragg grating 5 is a narrow-band optical fiber Bragg grating, with a reflection spectrum bandwidth generally to be controlled below 4 GHz. By this grating, single-frequency laser light output may be realized.

The working principle of the in-band pumping 975-nanomater single-frequency fiber laser with an ytterbium-doped silica optical fiber provided by the present invention will be described as below.

The 915-nanometer in-band pumping laser serves as an in-band pumping source of the 975-nanomater single-frequency fiber laser and is coupled into the ytterbium-doped silica optical fiber 4 via the optical fiber wavelength division multiplexer 2. The ground state level absorbs 915-nanometer, so that a transition of pumping from an energy level ²F_{7/2} to a high energy level ²F_{5/2} and from an excited state ²F_{5/2} to ²F_{7/2} occurs. In such a quasi-three-level structure, 975-nanomater photons will be generated. The generation of 975-nanomater single-frequency laser light is realized by using the highly ytterbium-doped optical fiber having a very short length and the narrow-band optical fiber Bragg grating. As the space between laser longitudinal modes is associated with the length of the laser chamber, the reduction of the length of the laser chamber may increase the space between laser longitudinal modes, so that it is beneficial to the selection of a single longitudinal mode. The narrow-band optical fiber Bragg grating may further limit the range of wavelength of the output laser light, and the narrow line-width 975-nanomater single-frequency laser light output is thus ultimately realized.

We claim:

1. An in-band pumping 975-nanometer single-frequency fiber laser with an ytterbium-doped silica optical fiber, comprising a 915-nanometer in-band pumping laser (1), an optical fiber wavelength division multiplexer (2), a high-reflectivity optical fiber Bragg grating (3), an ytterbium-doped silica optical fiber (4), a low-reflectivity optical fiber Bragg grating (5) and an output optical fiber (6), wherein the 915-nanometer in-band pumping laser (1) servers as an in-band pumping source; a pumping input port of the optical fiber wavelength division multiplexer (2) is connected to the in-band pumping laser (1); the 915-nanometer in-band pumping laser (1) pumps the ytterbium-doped silica optical fiber after passing through the optical fiber wavelength division multiplexer (2); one end of the high-reflectivity optical fiber Bragg grating (3) is connected to an output port of the optical fiber wavelength division multiplexer (2) while the other end thereof is connected to one end of the ytterbium-doped silica optical fiber (4); the low-reflectivity optical fiber Bragg grating (5) is connected to the other end of the ytterbium-doped silica optical fiber (4); and, single-frequency laser light is ultimately output from the output optical fiber (6) connected to the other end of the low-reflectivity optical fiber Bragg grating (5).

2. The in-band pumping 975-nanometer single-frequency fiber laser with an ytterbium-doped silica optical fiber according to claim 1, characterized in that the 915-nanometer in-band pumping laser (1) is a semiconductor laser or an all-solid-state laser, and a gain optical fiber is pumped in an in-band pumping manner.

3. The in-band pumping 975-nanomater single-frequency fiber laser with an ytterbium-doped silica optical fiber according to claim 1, characterized in that the high-reflectivity optical fiber Bragg grating (3) and the low-reflectivity optical fiber Bragg grating (5) form a laser chamber, and the central wavelengths of both the optical fiber Bragg gratings are greater than 915-nanometer.

4. The in-band pumping 975-nanomater single-frequency fiber laser with an ytterbium-doped silica optical fiber according to claim 1, characterized in that the reflection spectrum bandwidth single-frequency output by the low-reflectivity optical fiber Bragg grating (5) is below 4 GHz.

5. The in-band pumping 975-nanomater single-frequency fiber laser with an ytterbium-doped silica optical fiber according to claim 1, characterized in that a connection between the optical fiber wavelength division multiplexer (2) and the high-reflectivity optical fiber Bragg grating (3), a connection between the high-reflectivity optical fiber Bragg grating (3) and the ytterbium-doped silica optical fiber (4), a connection between the ytterbium-doped silica optical fiber (4) and the low-reflectivity optical fiber Bragg grating (5) and a connection between the low-reflectivity optical fiber Bragg grating (5) and the output optical fiber (6) are all realized by means of welding.
